(19) United States
(12) Patent Application Publication
(10) Pub. No.: US 2024/0150218 A1
(43) Pub. Date: May 9, 2024

(54) HOLLOW CORE OPTICAL FIBERS AND METHODS OF MAKING

(71) Applicant: CORNING INCORPORATED, Corning, NY (US)

(72) Inventors: Paulo Clovis Dainese, JR., Painted Post, NY (US); Matthew Ryan Drake, Painted Post, NY (US); Richard Michael Fiacco, Corning, NY (US); Brian Lee Harper, Painted Post, NY (US); Ming-Jun Li, Horseheads, NY (US); Silver Nyambo, Horseheads, NY (US); Matthew John Rice, Bath, NY (US); Jeffery Scott Stone, Addison, NY (US); Matthew Artus Tuggle, Corning, NY (US)

(21) Appl. No.: 18/387,631

(22) Filed: Nov. 7, 2023

Related U.S. Application Data
(60) Provisional application No. 63/423,560, filed on Nov. 8, 2022.

(51) Int. Cl. C03B 37/027; C03B 37/012; C03B 37/018

(52) U.S. Cl. CPC C03B 37/02718; C03B 37/01214; C03B 37/01876; C03B 2203/16

(57) ABSTRACT

A method of manufacturing a preform, the method including positioning at least one glass tube in a glass outer cladding to form a preform precursor, the glass tube comprising a first open end and a second open end, forming a preform from the preform precursor, and thermally treating at least one of the preform precursor and the preform. The thermally treating including sealing the first open end and the second open end of the glass tube to form a closed tube and heating and/or cooling the glass tube to manipulate gas pressure within the closed glass tube.

This application claims the benefit of priority of U.S. Provisional Application Ser. No. 63/423,560 filed on Nov. 8, 2022, the content of which is relied upon and incorporated herein by reference in its entirety.

### FIELD OF THE DISCLOSURE

The present disclosure is generally directed to hollow core optical fibers, and more specifically to anti-resonant hollow core optical fibers including methods of making thereof.

### BACKGROUND OF THE DISCLOSURE

Anti-resonant hollow core optical fibers are traditionally comprised of a hollow, outer cladding in which a plurality of structural tubes are arranged. The structural tubes have a smaller diameter and thickness than the outer cladding. Each structural tube is bonded to an inner surface of the outer cladding such that the structural tubes are arranged about the inner circumference of the outer cladding. Furthermore, each structural tube runs parallel to a length of the outer cladding. A central portion of the outer cladding, around which the structural tubes are arranged, remains empty as an air-filled void. The resulting anti-resonant fiber guides light through the empty-central portion of the core. Such anti-resonant fibers are able to provide reduced optical loss of signal.

The structural tubes must have specific dimensions in order to transmit the optical signal within the air-filled void formed by the outer cladding. If the structural tubes are not made with such specific dimensions, the structural tubes will not act as anti-resonant members at a predetermined wavelength. However, producing structural tubes with precise dimensions in hollow core optical fibers is extremely difficult.

### SUMMARY OF THE DISCLOSURE

An exemplary approach to solve the object is described by the independent claims. Various embodiments are defined with the dependent claims.

The present disclosure is directed to a hollow core optical fiber and methods of making thereof. According to aspects of the present disclosure, structural tubes are manufactured to have precise dimensions. More specifically, the structural tubes are manufactured so that an inner capillary, formed by the structural tubes, has a specific size and so that a wall thickness of the structural tubes has a specific size. Such allows the structural tube to be tuned to provide anti-resonance for predetermined wavelengths. In some embodiments, the structural tubes are specifically sized so that the structural tubes provide anti-resonance for wavelengths of about 1550 nm.

The structural tubes may be formed with such precise size dimensions by first forming glass tubes. The glass tubes are positioned around an inner cladding of a precursor to the hollow core optical fiber. Then, the glass tubes are heated to manipulate the gas pressure within the glass tubes. More specifically, an increase in temperature causes the gas pressure to increase, thus causing the structural tubes to be formed with a relatively larger capillary size and a relatively smaller wall thickness. One or more glass tubes may be manipulated separate and differently from one or more other glass tubes. The resulting hollow core optical fiber may be formed with precise dimensions so as to provide superior transmission of an optical signal.

According to a first aspect, a method of manufacturing a preform, the method comprising positioning at least one glass tube in a glass outer cladding to form a preform precursor, the glass tube comprising a first open end and a second open end, forming a preform from the preform precursor, and thermally treating at least one of the preform precursor and the preform. The thermally treating comprising sealing the first open end and the second open end of the glass tube to form a closed tube and heating and/or cooling the glass tube to manipulate gas pressure within the closed glass tube.

According to a second aspect, a method of manufacturing a preform, the method comprising positioning at least one glass tube in a glass outer cladding to form a preform precursor, the glass tube comprising a first open end and a second open end, forming a preform from the preform precursor, and thermally treating at least one of the preform precursor and the preform. The thermally treating comprising sealing the first open end and the second open end of the glass tube to form a closed tube and, after forming the closed tube, heating the glass tube to increase gas pressure within the closed glass tube.

Although many different embodiments are listed, the embodiments may exist individually or in any combination as possible. Hereinafter exemplary embodiments are shown and described.

### BRIEF DESCRIPTION OF THE DRAWINGS

FIG. 1A illustrates a cross-sectional view of an exemplary hollow core optical fiber, according to embodiments of the present disclosure;

FIG. 1B illustrates a cross-sectional view of another exemplary hollow core optical fiber, according to embodiments of the present disclosure;

FIG. 1C illustrates an enlarged view of a portion of the exemplary hollow core optical fiber of FIG. 1A, according to embodiments of the present disclosure;

FIG. 2 illustrates a process for producing a hollow core optical fiber, according to embodiments of the present disclosure;

FIG. 3A illustrates a cross-sectional view of an exemplary preform precursor to a hollow core optical fiber, according to embodiments of the present disclosure;

FIG. 3B illustrates a cross-sectional view of an exemplary preform to a hollow core optical fiber, according to embodiments of the present disclosure;

FIG. 3C illustrates radially outward pressure exerted on the walls of a glass tube of the preform precursor of FIG. 3A, according to embodiments of the present disclosure;

FIG. 4A illustrates a process for producing a hollow core optical fiber, according to embodiments of the present disclosure;

FIG. 4B illustrates a process for producing a hollow core optical fiber, according to embodiments of the present disclosure;

FIG. 4C illustrates a process for producing a hollow core optical fiber, according to embodiments of the present disclosure;

FIG. 5A illustrates a redraw process for producing a hollow core optical fiber, according to embodiments of the present disclosure;

FIGS. 5B and 5C illustrate the change in dimensions before and after the redraw process of FIG. 5A, according to embodiments of the present disclosure;

FIG. 6 illustrates a fiber drawing system, according to embodiments of the present disclosure;

FIGS. 7A and 7B illustrate cross-sectional views of exemplary examples of preform precursors and preforms before and after a thermal treatment step, according to embodiments of the present disclosure;

FIGS. 8A and 8B illustrate cross-sectional views of exemplary examples of preform precursors and preforms before and after a thermal treatment step, according to embodiments of the present disclosure;

FIG. 9 illustrates a cross-sectional view of exemplary example of a preform for producing hollow core optical fibers, according to embodiments of the present disclosure; and

FIGS. 10A-10C illustrate exemplary examples of producing preforms for hollow core optical fibers, according to embodiments of the present disclosure.

### DETAILED DESCRIPTION

Additional features and advantages of the disclosure will be set forth in the detailed description which follows and will be apparent to those skilled in the art from the description or recognized by practicing the disclosure as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

It will be understood by one having ordinary skill in the art that construction of the described disclosure, and other components, is not limited to any specific material. Other exemplary embodiments of the disclosure disclosed herein may be formed from a wide variety of materials, unless described otherwise herein.

It is also important to note that the construction and arrangement of the elements of the disclosure, as shown in the exemplary embodiments, is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel and nonobvious teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures, and/or members, or connectors, or other elements of the system, may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present disclosure. Other substitutions, modifications, changes, and omissions may be made in the design, operating conditions, and arrangement of the desired and other exemplary embodiments without departing from the spirit of the present disclosure.

Reference will now be made in detail to the present preferred embodiments of the disclosure, examples of which are illustrated in the accompanying drawings. Whenever possible, the same reference numbers will be used throughout the drawings to refer to the same or like parts.

As is known in the art, the behavior of gas is dictated by gas law such as the ideal gas law: PV=nRT, where P is the pressure of the gas, V is the volume of the gas, n is the number of moles of the gas, R is the ideal gas constant, and T is the temperature of the gas. The ideal gas law shows the relationship between temperature, pressure, volume, and number of moles of a gas. Aspects of the present disclosure utilize these relationships to efficiently produce hollow core optical fibers with specific dimensions. In some aspects of the present disclosure, the relationship between temperature, pressure, volume, and number of moles of a gas is utilized to efficiently produce the hollow core optical fibers. According to the embodiments of the present disclosure, hollow core optical fibers can be easily produced to have specific dimensions, including specific diameter sizes and wall thickness values.

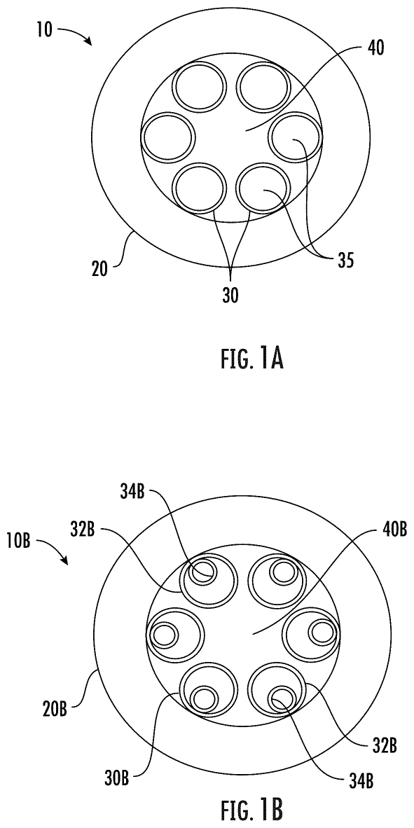

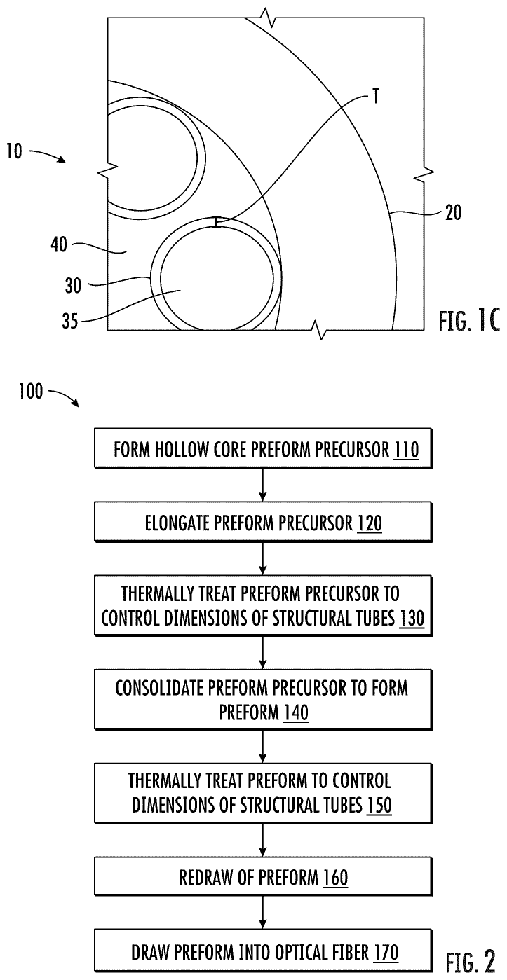

Referring now to FIG. 1A, an exemplary cross-sectional view of a hollow core optical fiber 10 is shown. Fiber 10 comprises an outer cladding 20, one or more structural tubes 30, and a hollow core 40. Structural tubes 30 are disposed radially around hollow core 40, and outer cladding 20 is disposed radially around structural tubes 30.

Outer cladding 20 is a hollow, cylindrical member formed of glass. Thus, outer cladding 20 has a hollow interior and forms a ring-like, donut shape in cross-section (as shown in FIG. 1A). In some embodiments, outer cladding 20 is formed of doped or undoped silica glass. Outer cladding 20 may have a length from about 10 cm to about 2 m, or about 25 cm to about 1.5 m, or about 50 cm to about 1 m.

Structural tubes 30 are glass tubes disposed within the hollow interior of outer cladding 20. Similar to outer cladding 20, structural tubes 30 are hollow, cylindrical members formed of glass. Thus, structural tubes 30 each form a ring-like, donut shape in cross-section (as shown in FIG. 1A). In some embodiments, structural tubes 30 are formed of doped or undoped silica glass. Structural tubes 30 may each have a length that extends the length (or substantially the length) of outer cladding 20. Thus, structural tubes 30 and outer cladding 20 may have the same length.

As shown in FIG. 1A, the hollow interior of each structural tube 30 forms a capillary 35 through which gas can flow, such as, for example, ambient air or nitrogen gas. As used herein, capillaries 35 are lumens formed by the walls of structural tubes 30. An outer diameter of each capillary 35 is defined by an inner diameter of each structural tube 30. A wall thickness of structural tubes 30 is carefully selected to optimize anti-resonant conditions in hollow core 40.

Hollow core 40 may be formed and defined by the outer profile of structural tubes 30. Thus, an outer surface of structural tubes 30 forms an outer diameter of hollow core 40. When in use, light is guided through the air in hollow core 40 along fiber 10. Structural tubes 30 help to maintain the light within hollow core 40. Such provides transmission of optical signals along fiber 10 with reduced transmission loss.

In some embodiments, hollow core optical fiber 10 is an anti-resonant hollow core optical fiber. As is known in the art, anti-resonant fibers are one type of hollow core fibers. There are three types of hollow core fibers. The first type is Bragg hollow core fibers in which the cladding is a Bragg structure of concentric periodic dielectric multilayers that confine light in a hollow (air) region. The second type is photonic bandgap hollow core fibers that use a two-dimensional photonic crystal structure with periodically arranged air holes that confine light in the hollow core region. The third type is anti-resonant hollow core fibers in which the fiber comprises one or more layers of thin glass structural tubes to prevent light from leaking out of the air core.

It is also noted that structural tubes 30 may be positioned in various configurations around an inner diameter of outer cladding 20. FIG. 1A shows a first embodiment in which fiber 10 comprises six structural tubes 30 evenly spaced around the inner diameter of outer cladding 20. However, fiber 10 may comprise more or less structural tubes 30. For example, fiber 10 may comprise two, three, four, five, seven, eight, nine, ten, eleven, twelve, or more structural tubes 30. Furthermore, structural tubes 30 may be evenly spaced apart from each other, or structural tubes 30 may be spaced apart inconsistently from each other. In yet some embodiments, one or more structural tubes 30 may be in contact with an adjacent structural tube 30 at a contact point. However, in general, adjacent structural tubes 30 are typically separated by a gap so as to avoid the formation of a waveguide at the contact point. More specifically, such a contact point between two structural tubes can form an increased wall thickness at the contact point (due to the additive wall thickness of the two structural tubes). The increased wall thickness forms a waveguiding region, which lowers the attenuation of the optical fiber.

FIG. 1B shows an embodiment in which fiber 10B comprises nested structural tubes 30B. More specifically, structural tubes 30B comprise an outer tube 32B (a first structural tube) and an inner tube 34B (a second structural tube) such that inner tube 34B is nested within outer tube 32B. It is also noted that fiber 10B comprises an outer cladding 20B and a hollow core 40B, similar to the embodiment of FIG. 1A. Furthermore, the present disclosure is not limited to the exemplary arrangements disclosed herein. Other embodiments and arrangements of structural tubes are also contemplated.

Each structural tube 30 may be formed to have various sizes, including various inner and outer diameters and various wall thickness values. As shown in FIG. 1C, structural tubes 30 have a wall thickness dimension T, which is defined by the inner and outer diameters of the structural tube. The size of structural tubes 30 (including the inner diameter, outer diameter, and wall thickness) affects the wavelengths at which the fiber is anti-resonant. For example, it has been found that a wall thickness of about 300 nm to about 450 nm in a hollow core optical fiber provides zero transmission through the walls of the structural tubes (so that the fiber is anti-resonant) at wavelengths from about 1200 nm to about 1600 nm. Altering the thickness of the hollow core optical fibers to be greater or less than the 300 nm to 450 nm range may then also alter the wavelength window to be greater or less than the about 1200 nm to about 1600 nm window. Embodiments of the present disclosure are directed towards processes and methods to control the size of the structural tubes, including the inner and outer diameter dimensions of the structural tubes and their wall thickness. Such dimensions also affect the size of capillaries 35 formed by structural tubes 30. The processes and methods disclosed herein to control the size of the structural tubes may be performed during different process steps of producing the hollow core optical fiber, as discussed below.

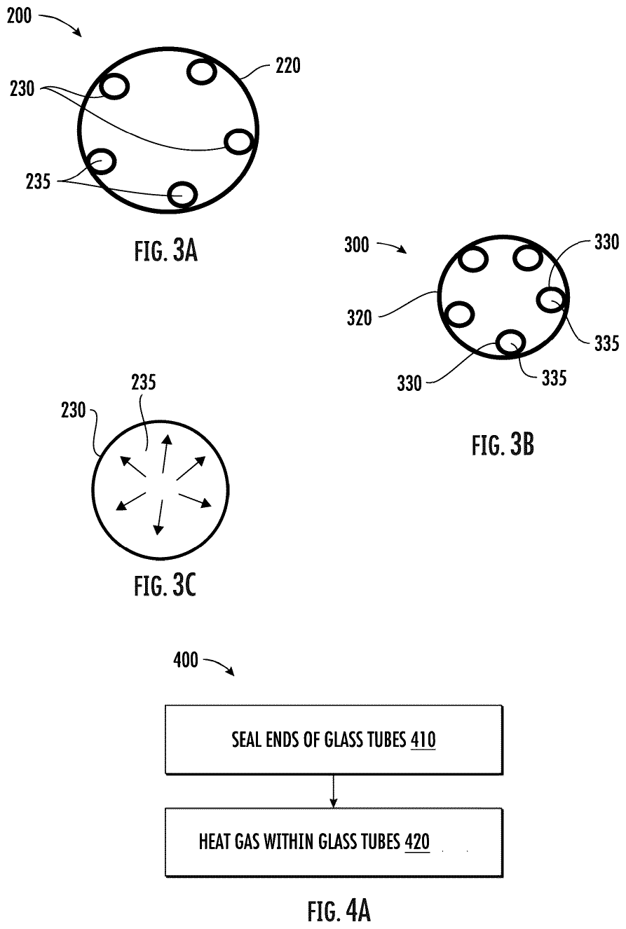

FIG. 2 provides an exemplary process 100 to produce a hollow core optical fiber. Step 110 of process 100 comprises forming a hollow core preform precursor, which is a precursor to a hollow core preform. As discussed further below, in embodiments, the preform precursor forms the preform after the consolidation step, and the preform can then be exposed to a redraw step before being drawn into a hollow core optical fiber. In some embodiments, step 110 of process 100 specifically comprises inserting one more glass tubes into a glass cladding tube to form the preform precursor. FIG. 3A shows an exemplary embodiment of glass tubes 230 inserted into a glass cladding tube 220 in a preform precursor 200. As shown in FIG. 3A, glass tubes 230 form inner capillaries 235. Glass tubes 230 become structural tubes 30 in the drawn optical fiber, and glass cladding tube 220 becomes outer cladding 20 in the drawn optical fiber. The preform precursor formed in step 110 (e.g., preform precursor 200) may be a precursor to preform 300 of FIG. 3B. It is noted that FIG. 3A shows an exemplary preform precursor 200 and that FIG. 3B shows an exemplary preform 300. However, embodiments of the present disclosure, including the steps of process 100, may be used with preform precursors and preforms having other configurations than those shown in FIGS. 3A and 3B. Reference to the specific embodiments of FIGS. 3A and 3B with regard to the steps of process 100 are used for illustrative purposes only.

Referring again to FIG. 2, at step 120 of process 100, preform precursor 200 is heated to a temperature above the softening point of glass to elongate and stretch preform precursor 200 into a smaller diameter preform precursor. Such causes inner capillaries 235 and glass tubes 230 to extend in length.

At step 130 of process 100, preform precursor 200 is thermally treated to control the dimensions of structural tubes 30 in the produced preform 300 and in the optical fiber drawn from preform 300. As discussed further below, the thermal treatment of preform precursor 200 comprises heating and/or cooling the preform precursor.

At step 140 of process 100, preform precursor 200 is heated to consolidate the glass. During consolidation, preform precursor 200 may be placed inside a furnace and heated to a temperature above the sintering temperature of the glass, which may be a temperature from about 1400° C. to about 2000° C., or about 1500° C. to about 1900° C., or about 1600° C. to about 1800° C., or about 1675° C. to about 1800° C., or about 1800° C. to about 1950° C., or about 1700° C. The glass may also be subjected to chlorine gas to remove impurities and reduce water content of the glass. Additional layers of soot (soot laydown) may be also applied to preform precursor 200 followed by additional consolidation steps. After the final consolidation step, a preform is formed. FIG. 3B shows an exemplary preform 300 that comprises glass tubes 330 disposed within a glass cladding tube 320. Glass tubes 330 form inner capillaries 335. Furthermore, glass tubes 330 become structural tubes 30 in the drawn optical fiber, and glass cladding tube 320 becomes outer cladding 20 in the drawn optical fiber. In embodiments, an outer diameter of preform 300 is less than an outer diameter of preform precursor 200.

It is noted that, in embodiments, the thermal treatment of step 130 is before the consolidation process of step 140. Therefore, the thermal treatment of step 130 is before the soot laydown of the consolidation of step 140.

Step 150 of process 100 comprises thermally treating preform 300 to control the dimensions of glass tubes 330 in preform 300 and to control the dimensions of structural tubes 30 in the optical fiber drawn from preform 300. As discussed further below, the thermal treatment of preform 300 comprises heating and/or cooling the preform. It is noted that the thermal treatment of step 150 is after the consolidation process of step 140 in embodiments. In particular, the thermal treatment of step 150 is after the soot laydown of the consolidation of step 140.

At step 160 of process 100, preform 300 is exposed to a redraw step before the preform is drawn into an optical fiber. More specifically, at step 160, preform 300 is heated to a temperature above the softening point of glass to stretch the preform into a smaller diameter preform. At the conclusion of step 160, the preform may be ready for drawing into an optical fiber. It is noted that the thermal treatment of step 150 is before the redrawing of step 160 in embodiments.

At step 170, preform 300 is drawn into an optical fiber. More specifically, preform 300 is drawn into a hollow core optical fiber. It is also noted that in some embodiments, process 100 may comprise more or less steps than shown in FIG. 2. For example, process 100 may not comprise thermal treatment step 130 or thermal treatment step 150. In some embodiments, process 100 comprises thermal treatment step 130 but does not comprise thermal treatment step 150. In yet some further embodiments, process 100 comprises thermal treatment step 130 but does not comprise thermal treatment step 150 and does not comprise redraw step 160. In the embodiments where process 100 does not comprise redraw step 160, the preform may be drawn into the optical fiber without being exposed to a redraw step. In yet some other embodiments, process 100 does not comprise the elongation of the preform at step 120 and/or the consolidation at step 140.

It is also noted that, in some embodiments, the thermal treatment of step 130 may be performed during the elongation of step 120. In particular, the heating of the preform precursor during step 120 may also comprise the thermal treatment of step 130. Furthermore, in some embodiments, the thermal treatment of step 130 and/or step 150 may be performed during the consolidation of step 140. In yet some other embodiments, the thermal treatment of step 150 may be performed during the redrawing of step 160.

As discussed above, embodiments of the present disclosure comprise thermally treating preform precursor 200 and/or preform 300 to control dimensions of glass tubes 330 in preform 300, which in turn control the dimensions of structural tubes 30 in the drawn optical fiber. In particular, in embodiments, the thermal treatment (step 130) is before soot laydown during consolidation of a preform precursor and/or the thermal treatment (step 150) is after soot laydown during consolidation of the preform precursor. During such thermal treatment(s), preform precursor 200 and/or preform 300 are thermally treated to control the capillary size and structural tube wall thickness in the drawn optical fiber. As discussed further below, thermally treating preform precursor 200 and/or preform 300 comprises modifying the gas pressure of capillaries 235/335 within glass tubes 230/330.

Gas pressure within capillaries 235 in preform precursor 200 and/or within capillaries 330 in preform 300 may be modified to increase or decrease the size of the capillaries. Such a change in gas pressure can cause the capillaries to increase or decrease in size, thus increasing or decreasing the wall thickness of glass tubes 230/330. For example, an increase in gas pressure within capillaries 235/335 causes the capillaries to expand in size, thus causing the wall thickness of glass tubes 230/330 to decrease. This further causes capillaries 35 in the drawn optical fiber 10 to have a relatively larger outer diameter and for structural tubes 30 in the drawn optical fiber 10 to have a relatively smaller wall thickness.

As an example, FIG. 3C depicts the radially outward pressure on the walls of a glass tube 230 from the increased gas pressure within capillary 235. As shown in FIG. 3C, the radially outward pressure causes the capillary 235 to inflate and expand in size, similar to a balloon, while the walls of glass tube 230 stretch and become thinner to accommodate the larger inner capillary size. Due to the relatively thinner walls of the glass tubes 230, less effort is needed to expand the glass tubes 230 during a fiber drawing step. Therefore, during the fiber drawing step, the glass tubes 230 can more easily expand to produce structural tubes 30 with relatively larger diameters. Accordingly, after the final drawing step, the produced structural tubes 30 are relatively larger in size with relatively larger capillaries 35.

In some embodiments, the gas pressure within capillaries 235/335 is increased by increasing the temperature of the gas within the capillaries. Furthermore, as discussed below, in embodiments, ends of glass tubes 230/330 are sealed to facilitate the change in pressure within the capillaries.

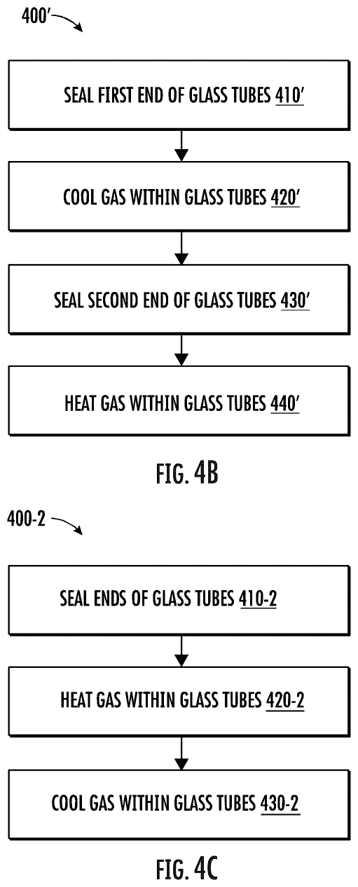

FIG. 4A shows a process 400 to thermally treat preform precursor 200 and/or preform 300. Therefore, process 400 provides more detailed process steps of step 130 and/or step 150 of process 100. Process 400 may be used when heating the gas within the capillaries to expand the capillaries. In step 410 of process 400, ends of glass tubes 230/330 are sealed to close capillaries 235/335. For example, the top and/or bottom of glass tubes 230/330 may be sealed through welding, heating, or any other means to seal the ends of the glass tubes. The ends of glass tubes 230/330 may be sealed while the gas inside the glass tubes is at room temperature (about 25° C.). After the sealing process, glass tubes 230/330 form closed tubes.

Sealing of glass tubes 230/330 helps to maintain a constant volume and number of gas moles of gas within capillaries 235/335. With such constant gas volume and number of moles, the gas pressure within the capillaries can be more easily regulated and controlled when the temperature is increased.

Step 420 of process 400 comprises heating the gas within glass tubes 230/330. More specifically, step 420 comprises heating the gas within one or more glass tubes 230 in preform precursor 200 and/or within or one or more glass tubes 330 in preform 300. During step 420, glass tubes 230/330 may be heated with, for example, a heated sleeve, ring burner, heated air blower, induction coil, torch, isothermal heating element, laser including a CO or CO₂ laser, plasma heater, furnace, or any other heating element as is known in the art.

It is also noted that one or more glass tubes may not be subject to the heating of step 420. Therefore, in one exemplary embodiment, a first glass tube in a preform (or in a preform precursor) is heated to increase the capillary size of that glass tube while an adjacent second glass tube is not subjected to the heating of thermal treatment steps 130/150. Therefore, the capillary size of the second glass tube does not change in these pre-draw steps.

In some particular embodiments, step 420 comprises heating one or more nested glass tubes (e.g., inner tube 34B) different from one or more other glass tubes (e.g., outer tube 32B) during the thermal treatment steps 130/150. For example, the precursor to inner tube 34B may be heated to a higher temperature than the precursor to outer tube 32B during thermal treatment step 130 and/or 150, causing the precursor to inner tube 34B to have a relatively larger expansion rate than the precursor to outer tube 32B. In embodiments in which one or more nested glass tubes (e.g., inner tube 34B of FIG. 1B) is heated differently from one or more other glass tubes (e.g., outer tube 32B of FIG. 1B), it is contemplated that one or more glass tubes may be sealed while one or more glass tubes remains unsealed. For example, the precursor to inner tube 34B may be sealed and thermally treated (during step 130 and/or step 150) while the precursor to outer tube 32B is not sealed and/or thermally treated.

In some embodiments, the glass tubes are heated uniformly along their length. In other embodiments, the glass tubes are heated inconsistently along their length. For example, it is contemplated that a glass tube may be heated such that the gas within the glass tube is heated to a first temperature in a first portion of the glass tube, heated to a second temperature in a second portion of the glass tube, and heated to a third temperature in a third portion of the glass tube, the first temperature being higher than the second temperature and the second temperature being higher than the third temperature and such that the first, second, and third portions are disposed longitudinally along the length of the glass tube. In yet other embodiments, the glass tubes may be inconsistently heated radially along an axial length of the glass tubes. In these embodiments, for example, a glass tube may be heated such that the gas within the glass tube is heated to a relatively higher temperature at a radially central portion of the glass tube and heated to a relatively lower temperature at a radially peripheral portion of the glass tube. In another embodiment, a glass tube may be heated such that the gas within the glass tube is heated to a relatively higher temperature on a first radial side (e.g., left side) of the glass tube and heated to a relatively lower temperature on a second radial side (e.g., right side) of the glass tube.

During step 420 of process 400, glass tubes 230/330 may be heated to a temperature above the strain point (about 1100° C. or above) of the glass. In yet some embodiments, the glass tubes 230/330 are heated to a temperature above the softening point (about 1100° C. or above, or about 1200° C. or above, or about 1300° C. or above) of the glass. Such heating of the glass allows glass tubes 230/330 to stretch (due to the increase in pressure within the glass tubes), resulting in thinner walls and an increased size of capillaries 235/335. Because the ends of glass tubes 230/330 are sealed (and, thus, the volume of gas and number of moles of the gas within the glass tubes remains constant), the heating of glass tubes 230/330 causes the gas pressure within capillaries 235/335 to increase. Such an increase in gas pressure causes capillaries 235/335 to expand to be larger in size while the wall thickness of glass tubes 230/330 decreases. In some embodiments, glass tubes 230/330 (and also the gas within the tubes) are heated to a temperature from about 1100° C. to about 2200° C., or about 1500° C. to about 2100° C., or about 1600° C. to about 2000° C., or about 1700° C. to about 1900° C., or about 1800° C. to about 2000° C., or about 1100° C. to about 1700° C., or about 1300° C. to about 1600° C., or about 1400° C. to about 1500° C., or about 1450° C. to about 1550° C. during step 420 of process 400. Glass tubes 230/330 may be heated for a duration of about 0.01 seconds to about 12 hours, or about 1 second to about 10 hours, or about 5 seconds to about 8 hours, or about 30 seconds to about 6 hours, or about 1 minute to about 4 hours, or about 10 minutes to about 2 hours, or about 30 minutes to about 8 hours, or about 30 minutes to about 4 hours, or about 30 minutes to about 2 hours, or about 1 hour to about 4 hours. As discussed above, heating of glass tubes 230/330 in step 420 causes structural tubes 30 in the drawn optical fiber to have a larger capillary diameter and thinner walls.

As discussed above, the steps of process 400 may be conducted during any of steps 130 and/or 150 of process 100. Therefore, the steps of process 400 are conducted prior to the drawing of the optical fiber (prior to step 170 of process 100).

As discussed above, the thermal treatment of step 130 and/or step 150 may be a separate step that is distinct from the elongation of step 120, the consolidation of step 140, and the redrawing of step 160. However, in other embodiments, the thermal treatment of step 130 and/or step 150 is part of and encompasses at least one of the elongation of step 120, the consolidation of step 140, and/or the redrawing of step 160. For example, heating the preform precursor in order to elongate the preform precursor during the elongation of step 120 may also comprise the thermal treatment of step 130 (along with sealing the ends of the preform precursor). Therefore, the heating is sufficient to not only elongate the preform precursor but also to thermally treat the preform precursor to expand the capillaries (as discussed above). As another example, heating the preform in order to consolidate the preform precursor during the consolidation of step 140 may also comprise the thermal treatment of step 130 (along with sealing the ends of the preform precursor). Therefore, the heating is sufficient to not only consolidate the preform precursor but also to thermally treat the preform precursor to expand the capillaries (as discussed above). As another example, heating the preform in order to redraw the preform during the redraw of step 160 may also comprise the thermal treatment of step 150 (along with sealing the ends of the preform). Therefore, the heating is sufficient to not only redraw the preform but also to thermally treat the preform to expand the capillaries (as discussed above). It is also noted that the thermal treatment process affects the expansion amount in structural tubes 30. More specifically, when heating the glass tubes during the thermal treatment of steps 130 and/or 150, a higher change in temperature causes a greater expansion amount as compared with a lower change in temperature.

In some exemplary examples of the processes disclosed herein, during step 410 of process 400, glass tubes 230 are sealed while the gas within the tubes is at room temperature (about 25° C.). Then, glass tubes 230 are heated before consolidation of the glass tubes. Therefore, in these exemplary examples, glass tubes 230 are heated during step 130 of process 100. In particular, glass tubes 230 (and the gas within the tubes) are heated to a temperature of about 1750° C., which causes the gas pressure within glass tubes 230 to increase to about 100 psi. After the consolidation of the glass tubes (step 140), the glass tubes of the resulting preform are relatively larger in diameter and have relatively smaller wall thicknesses. The resulting preform is then drawn into an optical fiber such that structural tubes 30 also have a relatively larger diameter. In these exemplary examples, due to the increase in temperature from room temperature to about 1750° C. of glass tubes 230 during step 130, structural tubes 30 may experience an expansion of about 2× from structural tubes in similar fibers that were not produced with the thermal treatment of step 130.

In other exemplary examples, glass tubes 230 (and the gas within the tubes) are heated to a first temperature. In one particular example, the first temperature is about 100° C. After heating to the first temperature, the ends of glass tubes 230 are sealed in step 410 of process 400 such that glass tubes 230 are closed tubes. Next, glass tubes 230 are heated before consolidation of the glass tubes. Therefore, in these exemplary examples, glass tubes 230 are heated during step 130 of process 100. In particular, glass tubes 230 (and the gas within the tubes) are heated to a temperature of about 1750° C. After the consolidation of the glass tubes (step 140), the glass tubes of the resulting preform are relatively larger in diameter and have relatively smaller wall thicknesses. The resulting preform is then drawn into an optical fiber such that structural tubes 30 also have a relatively larger diameter. In these exemplary examples, due to the increase in temperature from the first temperature (100° C.) to the second temperature (1750° C.), structural tubes 30 may experience an expansion of only about 1.5× from structural tubes in similar fibers that were not produced with the thermal treatment of step 130. It is noted that these second exemplary examples experienced a lower expansion rate than the previous exemplary examples (1.5× vs. 2×) due to the smaller increase in temperature from the first temperature to the second temperature, which is a result of the higher first temperature in these second exemplary examples (100° C. vs. room temperature). Furthermore, these second exemplary examples expanded at a slower and more controlled rate than the previous exemplary examples due to the sealing of glass tubes 230 at the elevated temperature of 100° C.

With reference to FIG. 4B, process 400′ illustrates another process to thermally treat preform precursor 200 and/or preform 300. Therefore, similar to process 400, process 400′ also provides more detailed process steps of step 130 and/or step 150 of process 100. Process 400′ may be used when heating the gas within the capillaries to expand the capillaries. However, as discussed further below, the steps of process 400′ result in a larger expansion of the glass tubes than the steps of process 400.

In step 410′ of process 400′, a first end of glass tubes 230/330 are sealed. The first end may be a top end of the glass tubes. It is noted that a second end (e.g., bottom end) of the glass tubes remain open during step 410′. At step 420′ of process 400′, the gas within glass tubes 230/330 is cooled. For example, the gas may be cooled to a temperature of about room temperature (about 25° C.) or lower, or about 10° C. or lower, or about 5° C. or lower, or about 0° C. or lower, or about −5° C. or lower or about −10° C. or lower, or about −15° C. or lower, or about −25° C. or lower, or about −35° C. or lower, or about −50° C. or lower, or about −75° C. or lower, or about −100° C. or lower. In embodiments, glass tubes 230/330 are cooled to a temperature from about 25° C. to about −100° C., or about 0° C. to about −75° C., or about 0° C. to about −50° C. The cooling of the glass tubes in step 420′ causes the gas to contract so that the gas molecules are more densely packed within the glass tubes. This then provides room for more gas molecules to enter the glass tubes. Therefore, although the volume that the gas occupies remains constant, the number of moles of gas increases (due to the addition of more gas molecules in the glass tubes).

In step 430′ of process 400′, the second end of glass tubes 230/330 is sealed, thus forming a closed glass tube. The second end may be a bottom end of the glass tubes. It is noted that the second end of the glass tubes is sealed while the gas is at the cooled temperature.

During step 440′ of process 400′, glass tubes 230/330 may be heated to a temperature above the strain point (about 1100° C. or above) of the glass. In yet some embodiments, the glass tubes 230/330 are heated to a temperature above the softening point (about 1100° C. or above, or about 1200° C. or above, or about 1300° C. or above) of the glass. Such heating of the glass allows glass tubes 230/330 to stretch (due to the increase in pressure within the glass tubes), resulting in thinner walls and an increased size of capillaries 235/335. Because the ends of glass tubes 230/330 are now sealed, the heating of glass tubes 230/330 causes an increase in temperature of the gas within glass tubes 230/330, which causes the gas pressure within capillaries 235/335 to increase. As discussed above, such an increase in gas pressure causes capillaries 235/335 to expand to be larger in size while the wall thickness of glass tubes 230/330 decreases. In some embodiments, glass tubes 230/330 (and also the gas within the tubes) are heated to a temperature from about 1100° C. to about 2200° C., or about 1500° C. to about 2100° C., or about 1600° C. to about 2000° C., or about 1700° C. to about 1900° C., or about 1800° C. to about 2000° C., or about 1100° C. to about 1700° C., or about 1300° C. to about 1600° C., or about 1400° C. to about 1500° C., or about 1450° C. to about 1550° C. during step 420 of process 400, as also discussed above with reference to process 400. Glass tubes 230/330 may be heated for a duration of about 0.01 seconds to about 12 hours, or about 1 second to about 10 hours, or about 5 seconds to about 8 hours, or about 30 seconds to about 6 hours, or about 1 minute to about 4 hours, or about 10 minutes to about 2 hours, or about 30 minutes to about 8 hours, or about 30 minutes to about 4 hours, or about 30 minutes to about 2 hours, or about 1 hour to about 4 hours, as also discussed above with reference to process 400.

Because glass tubes 230/330 were first cooled in step 420′ of process 400′, a larger number of gas moles was introduced into the glass tubes as compared to process 400 (which does not comprise such a cooling step). Therefore, process 400′ encompasses not only increasing the temperature of the gas within the glass tubes (step 440′), which increases the pressure within the glass tubes, but also increasing the number of moles of gas within the glass tubes (step 420′). Because the number of gas moles increased during step 420′, more gas molecules were heated during step 440′. Therefore, the pressure within glass tubes 230/330 increased to a greater amount as compared with process 400.

FIG. 4C illustrates a second embodiment in which glass tubes 230/330 are cooled during the thermal treatment of step 130 and/or 150. In this embodiment, the gas within the glass tubes is cooled such that the gas has a reduced temperature, which causes a decrease in gas pressure within the glass tubes. In particular, because the ends of the glass tubes are sealed (and, thus, the number of moles of gas within the glass tubes remains constant), the cooling of the glass tubes causes the gas pressure within capillaries 235/335 to decrease. Such a decrease in gas pressure causes capillaries 235/335 to deflate so that they are relatively smaller in size, while a wall thickness of the glass tubes increases. Due to the increased wall thickness, more effort is needed to expand the glass tubes 230/330 during a fiber drawing step. Therefore, during the fiber drawing step, the glass tubes 230/330 cannot expand as easily and, thus, produce structural tubes 30 with relatively smaller diameters. Accordingly, after the final drawing step, the produced structural tubes 30 are relatively smaller in size with relatively smaller capillaries 35.

As shown in process 400-2 of FIG. 4C, the thermal treatment of steps 130 and/or 150 of process 100 may comprise sealing both ends of glass tubes 230/330 (step 410-2) to form closed tubes. In embodiments, the gas within glass tubes 230/33 is at room temperature during step 410-2. At step 420-2 of process 400-2, glass tubes 230/330 may be heated to a temperature above the strain point (about 1100° C. or above) of the glass. In yet some embodiments, the glass tubes 230/330 are heated to a temperature above the softening point (about 1100° C. or above, or about 1200° C. or above, or about 1300° C. or above) of the glass. Such heating of the glass tubes may be performed as disclosed above with regards to process 400 and process 400′. Therefore, in embodiments, glass tubes 230/330 (and also the gas within the tubes) are heated to a temperature from about 1100° C. to about 2200° C., or about 1500° C. to about 2100° C., or about 1600° C. to about 2000° C., or about 1700° C. to about 1900° C., or about 1800° C. to about 2000° C., or about 1100° C. to about 1700° C., or about 1300° C. to about 1600° C., or about 1400° C. to about 1500° C., or about 1450° C. to about 1550° C. during step 420-2. Glass tubes 230/330 may be heated for a duration of about 0.01 seconds to about 12 hours, or about 1 second to about 10 hours, or about 5 seconds to about 8 hours, or about 30 seconds to about 6 hours, or about 1 minute to about 4 hours, or about 10 minutes to about 2 hours, or about 30 minutes to about 8 hours, or about 30 minutes to about 4 hours, or about 30 minutes to about 2 hours, or about 1 hour to about 4 hours, as also discussed above with reference to process 400.

At step 430-2 of process 400-2, the gas within glass tubes 230/330 is cooled. For example, the gas may be cooled to a temperature of about room temperature (about 25° C.) or lower, or about 10° C. or lower, or about 5° C. or lower, or about 0° C. or lower, or about −5° C. or lower or about −10° C. or lower, or about −15° C. or lower, or about −25° C. or lower, or about −35° C. or lower, or about −50° C. or lower, or about −75° C. or lower, or about −100° C. or lower. In embodiments, glass tubes 230/330 are cooled to a temperature from about 25° C. to about −100° C., or about 0° C. to about −75° C., or about 0° C. to about −50° C. In other embodiments, the gas within the glass tubes 230/330 are cooled so that the temperature of the glass tubes still remains above the strain point of the glass, or above the softening point of the glass. The cooling of the glass tubes in step 430-2 causes the gas to contract so that the glass tubes deflate inwards.

As discussed above, cooling of glass tubes 230/330 in step 430-2 causes structural tubes 30 in the drawn optical fiber to have a smaller capillary diameter and thicker walls. Furthermore, as also discussed above, the steps of process 400-2 may be conducted during any of steps 130 and/or 150 of process 100. Therefore, the steps of process 400-2 are conducted prior to the drawing of the optical fiber (prior to step 170 of process 100).

In some exemplary examples, glass tubes 230 (and the gas within the tubes) are at a first, initial temperature of about 25° C. when both ends of glass tubes 230 are sealed. Next, glass tubes 230 are heated in step 420-2 of process 400-2 and then cooled in step 430-2. In particular, in these examples, glass tubes 230 (and the gas within the tubes) are cooled to a temperature of about −50° C. during step 430-2 so that the gas within the glass tubes is at a pressure of 14.7 psi. After cooling of glass tubes 230, the glass tubes are consolidated in step 140 of process 100. After the consolidation step, the glass tubes of the resulting preform are relatively smaller in diameter and have relatively larger wall thicknesses. The resulting preform is then drawn into an optical fiber such that structural tubes 30 also have a relatively smaller diameter.

It is noted that embodiments of the present disclosure encompass combining one or more steps of processes 400, 400′, and 400-2. For example, a first glass tube in a preform (or in a precursor) may be heated by the steps of process 400 or process 400′, while a second glass tube in the same preform (or in the same preform precursor) may be cooled by the steps of process 400-2. Such may be advantageous when, for example, it is desired to increase the capillary size of the first glass tube and to decrease the capillary size of the second glass tube.

During step 420′ of process 400′ and/or during step 430-2 of process 400-2, glass tubes 230/330 may be cooled with, for example, a cooling gas or liquid (such as helium or nitrogen), dry ice, refrigerator, or any other cooling element as is known in the art.

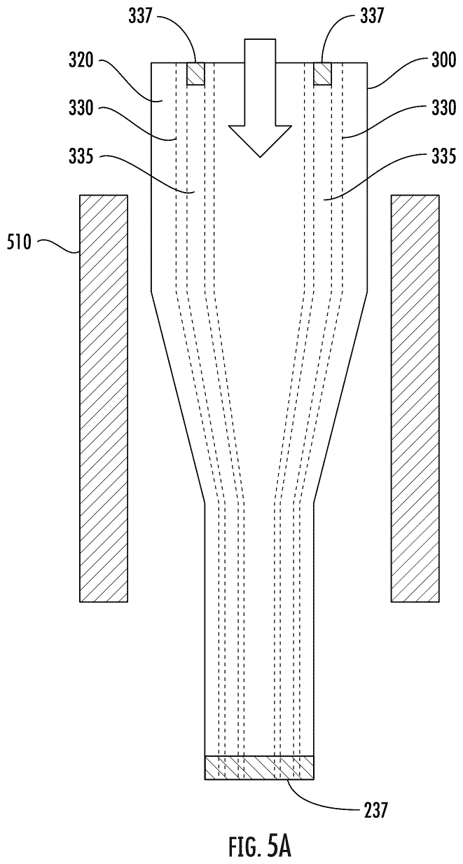

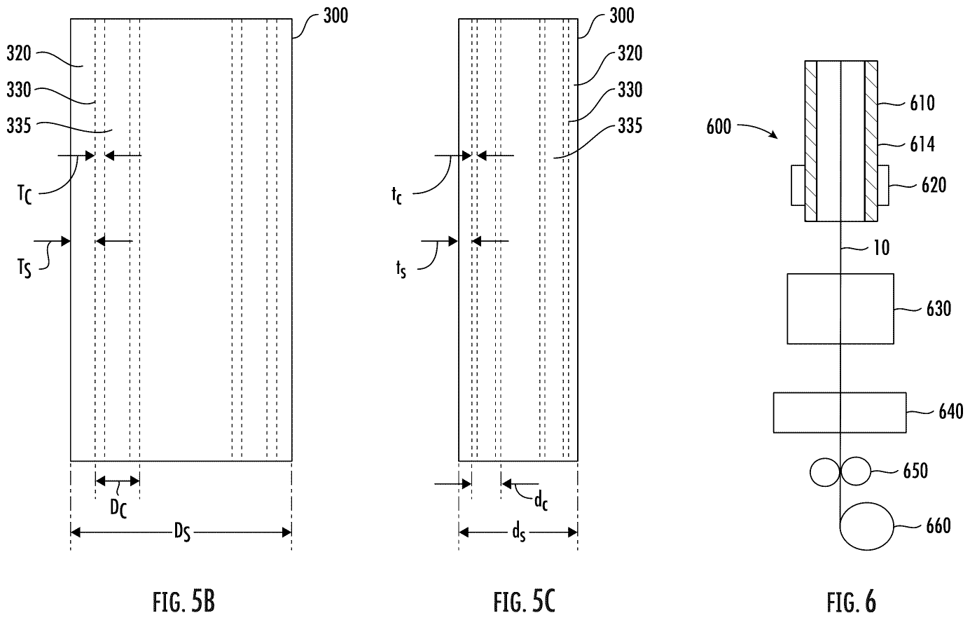

Referring again to the embodiments in which the glass tubes are heated to increase the capillary size and with reference to FIGS. 5A-5C, an exemplary embodiment is described in which a preform 300 was thermally treated in step 150 of process 100 before the redraw of step 160. FIG. 5A shows the dimensions of preform 300 during the exemplary redraw of step 160 and after the thermal treatment of preform 300. As shown in FIG. 5A, preform 300 is disposed in a redraw furnace with a heating element 510. The sealed ends of glass tubes 330 in preform 300 are depicted in FIG. 5A with reference numeral 337. Due to the heat from heating element 510, preform 300 can be stretched into a preform with a relatively smaller outer diameter. The heat from heating element 510 (along with the sealed ends of glass tubes 330) also causes the wall thickness of glass tubes 330 to decrease.

FIGS. 5B and 5C more clearly show the decrease in wall thickness of glass tubes 330 and the increase in size of capillaries 335 during the redrawing of preform 300 (and after the thermal treatment of step 150). As shown in FIG. 5B, before the redrawing step, glass tubes 330 have a wall thickness T_{c} and an outer diameter D_{c}. Furthermore, as shown in FIG. 5C, after the redrawing step, glass tubes 330 have a wall thickness t_{c}, and an outer diameter d_{c}. According to embodiments disclosed herein, T_{c}>t_{c} and D_{c}>d_{c}. In some embodiments, T_{c} is from about 0.25 mm to about 4.0 mm, or from about 0.5 mm to about 3.5 mm, or from about 1.0 mm to about 3.0 mm, or from about 1.5 mm to about 2.5 mm, or from about 2.0 mm to about 3.0 mm. In some embodiments, t_{c} is about 1.00 mm or less, or about 0.75 mm or less, or about 0.50 mm or less, or about 0.25 mm or less, or about 0.20 mm or less, or about 0.10 mm or less, or in a range from about 0.10 mm to about 1.00 mm, or from about 0.20 mm to about 0.75 mm, or from about 0.25 mm to about 0.50 mm. Furthermore, in some embodiments, D_{c} is in a range from about 2 nm to about 45 nm, or from about 5 nm to about 30 nm, or from about 8 nm to about 25 nm, or from about 10 nm to about 20 nm. In some embodiments, d_{c} is from about 0.25 mm to about 10 mm, or from about 0.50 mm to about 8 mm, or from about 1 mm to about 5 mm, or from about 2 mm to about 4 mm. A ratio of T_{c}:t_{c} and a ratio of D_{c}:d_{c} are each about 1.5 or more, or about 2 or more, or about 3 or more, or about 4 or more, or about 5 or more, or about 6 or more, or in a range from about 1.5 to about 6.

FIGS. 5B and 5C also show that a wall thickness of glass cladding tube 320 decreases from before the redrawing of preform 300 (Tₛ) to after the redrawing of preform 300 (tₛ). Additionally, an outer diameter of preform 300 decreases from before the redrawing of preform 300 (Dₛ) to after the redrawing of preform 300 (Dₛ). Thus, Tₛ>tₛ and Dₛ>dₛ. In some embodiments, Tₛ is from about 5 mm to about 50 mm, or from about 10 mm to about 40 mm, or from about 20 mm to about 30 mm. In some embodiments, tₛ is from about 0.5 mm to about 3.0 mm, or about 0.75 mm to about 2.5 mm, or about 1.0 mm to about 2.25 mm, or about 1.25 mm to about 2.0 mm, or about 1.5 mm to about 1.75 mm, or about 1.5 mm to about 2.0 mm. Furthermore, in embodiments, D s is from about 30 mm to about 150 mm, or from about 50 mm to about 125 mm, or from about 75 mm to about 100 mm, or from about 80 mm to about 90 mm. In embodiments, dₛ is from about 10 mm to about 80 mm, or about 12.5 mm to about 75 mm, or about 15 mm to about 60 mm, or about 20 mm to about 50 mm, or about 12.5 mm to about 75 mm, or about 15 mm to about 20 mm.

As discussed above, in step 170 of process 100, preform 300 is drawn into an optical fiber. FIG. 6 depicts an exemplary fiber drawing system 600 that comprises a draw furnace 610 with a heating element 620 and a muffle 614. Preform 300 is disposed vertically in draw furnace 600, and heating element 620 of draw furnace 610 applies heat to at least a bottom portion of preform 300. An optical fiber 10 (in the form of a bare, uncoated optical fiber) is then drawn from the heated preform 300.

In order to draw fiber 10, a root portion of preform 300 is pulled by a tractor 650 and wound onto a spoon or reel 660. System 600 may comprise additional components such as a monitor 630 to monitor the draw speed of optical fiber 10. Additionally, system 100 may further comprise a coating apparatus 640. Optical fiber 10 is a bare, uncoated fiber until reaching coating apparatus 640, which may apply a polymeric-based coating to an outside surface of the bare optical fiber. The coated fiber may then pass through a coating curing apparatus (not shown) before being wound on reel 660.

### Exemplary Examples

In a first exemplary example, a hollow core preform precursor was formed by positioning six glass tubes in a glass cladding tube. The glass tubes were evenly spaced around an inner diameter of the glass cladding tube such that adjacent glass tubes were separated by a gap. The preform precursor was then consolidated before being exposed to a thermal treatment step. Before the thermal treatment step, the glass tubes had an average inner diameter of 0.31 mm and an average outer diameter of 0.47 mm. The glass cladding tube had an inner diameter of 2.52 mm and an outer diameter of 12.42 mm. During the thermal treatment, the glass tubes were first sealed at both their top and bottom ends to form closed tubes while the gas within the tube was at 25° C. Then, the preform was heated in a furnace at atmospheric pressure. The furnace was heated to 1475° C. at a rate of 10° C./min and then held at 1475° C. for 30 minutes.

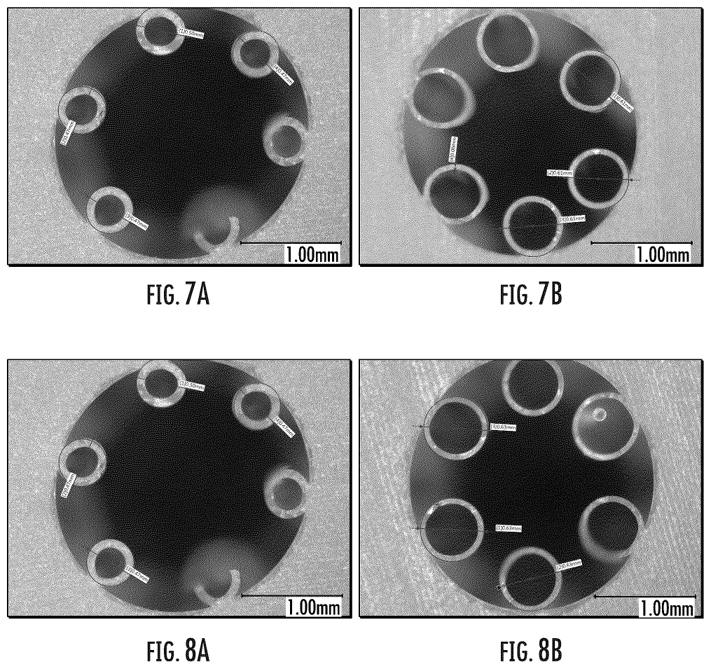

FIG. 7A shows a middle portion of the preform after the consolidation step and before the thermal treatment step. FIG. 7B shows the same middle portion but after the consolidation step and after the thermal treatment step. As shown in FIG. 7B, after the thermal treatment step, the glass tubes of the produced preform had an average inner diameter of 0.49 mm and an average outer diameter of 0.61 mm. Therefore, the inner diameter of each glass tube increased while the wall thickness decreased due to the thermal treatment of heating the preform precursor to 1475° C., as discussed above.

FIG. 8A shows a bottom portion of the same preform after the consolidation step and before the thermal treatment step. FIG. 8B shows the same bottom portion but after the consolidation step and after the thermal treatment step. As shown in FIG. 8B, after the thermal treatment step, the glass tubes of the produced preform had an average inner diameter of 0.0.51 mm and an average outer diameter of 0.63 mm. Therefore, the inner diameter of each glass tube increased while the wall thickness decreased due to the thermal treatment of heating the preform precursor to 1475° C., as discussed above.

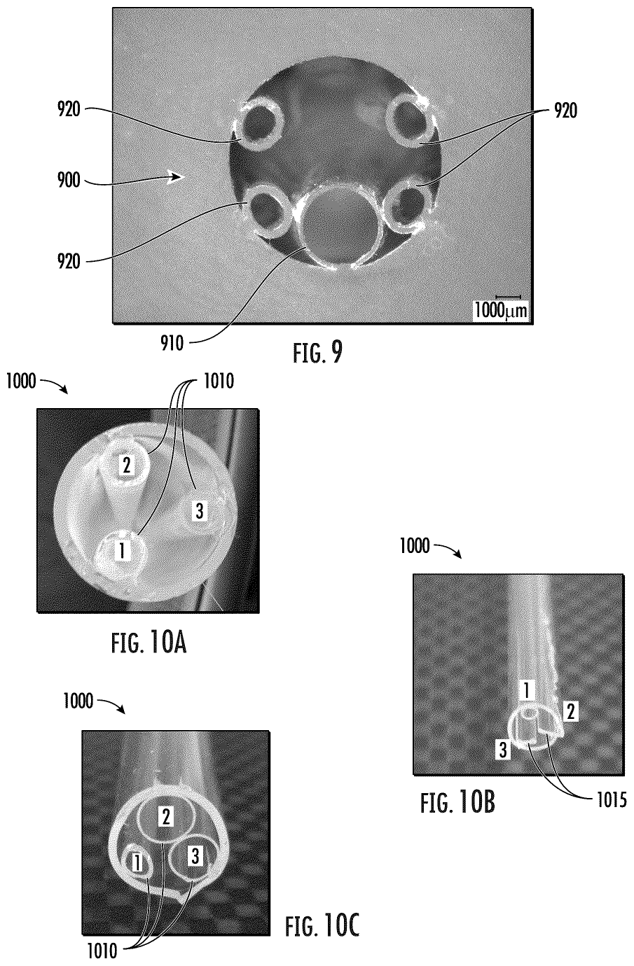

FIG. 9 shows an exemplary preform made using the embodiments of the present disclosure. Specifically, in the preform 900 of FIG. 9, before the consolidation step, glass tube 910 was sealed whereas glass tubes 920 were not sealed. Furthermore, after the sealing of glass tube 910, preform 900 was exposed to a thermal treatment step in which the preform was heated to a temperature of 1350° C. for 4-6 hours prior to consolidation. All of the glass tubes 910, 920 were then exposed to the same consolidation process. Because glass tube 910 was sealed during the thermal treatment step, the pressure within this glass tube increased, causing an increase in capillary size of the glass tube and a decrease in wall thickness of the glass tube (as shown in FIG. 9). However, glass tubes 920 were not sealed and, thus, did not experience the same change in size.

FIGS. 10A-10C show another exemplary embodiment in which glass tubes in a preform were sealed prior to a redraw step. FIG. 10A shows preform 1000 with glass tubes 1010 prior to the redraw step. In this exemplary embodiment, glass tubes 1010-2 and 1010-3 were sealed prior to the redraw step and then thermally treated during the redrawing of the preform. However, in this exemplary embodiment, glass tube 1010-1 was not sealed but was exposed to the same thermal treatment during the redrawing of the preform as the other glass tubes. In this exemplary embodiment, glass tubes 1010 were heated to a temperature of 1780° C. during the redraw step. FIG. 10B shows the sealed ends 1015 of glass tubes 1010-2 and 1010-3 prior to the redraw step. FIG. 10C shows preform 1000 after the redraw step (and, thus, after the thermal treatment step). As shown in FIG. 10C, glass tubes 1010-2 and 1010-3 have larger capillary sizes and decreased wall thickness values as compared with glass tube 1010-1. Table 1 below provides dimensions of preform 1000 before and after the redraw process.

TABLE 1

| | Before Redraw | | | After Redraw | | | |
|---|---|---|---|---|---|---|---|
| | Wall | Outer | | Wall | Outer | | |
| | Thick- | Dia- | | Thick- | Dia- | | |
| | ness | meter | | ness | meter | | Ex- |
| | of Glass | of Glass | Ratio | of Glass | of Glass | Ratio | pan- |
| | Tube | Tube | of | Tube | Tube | of | sion |
| | (T_{c}) | (D_{c}) | T_{c}/D_{c} | (t_{c}) | (d_{c}) | t_{c}/d_{c} | Factor |
| Structural | 1.00 mm | 8.00 mm | 0.125 | 0.41 mm | 2.16 mm | 0.190 | 0.659 |
| Tube | | | | | | | |
| 1010-1 | | | | | | | |
| Structural | 1.00 mm | 8.00 mm | 0.125 | 0.22 mm | 3.67 mm | 0.060 | 2.090 |
| Tube | | | | | | | |
| 1010-2 | | | | | | | |
| Structural | 1.00 mm | 8.00 mm | 0.125 | 0.26 mm | 3.57 mm | 0.073 | 1.720 |
| Tube | | | | | | | |
| 1010-3 | | | | | | | |

As shown above in Table 1, structural tube 1010-1 was not sealed during the thermal treatment step and, therefore, had the largest wall thickness and smallest diameter after the redraw. Furthermore, structural tube 1010-1 also had the smaller expansion rate of the three structural tubes.

As discussed above, embodiments of the present disclosure are directed to methods of producing hollow core optical fiber such that the fibers have specific size dimensions. More specifically, the structural tubes of the fibers are manufactured so that an inner capillary, formed by the structural tubes, has a specific size and so that a wall thickness of the structural tubes has a specific size. Such allows the structural tube to be tuned to provide anti-resonance for predetermined wavelengths. In some embodiments, the structural tubes are specifically sized so that the structural tubes provide anti-resonance for wavelengths of about 1550 nm.

While various embodiments have been described herein, they have been presented by way of example only, and not limitation. It should be apparent that adaptations and modifications are intended to be within the meaning and range of equivalents of the disclosed embodiments, based on the teaching and guidance presented herein. It therefore will be apparent to one skilled in the art that various changes in form and detail can be made to the embodiments disclosed herein without departing from the spirit and scope of the present disclosure. The elements of the embodiments presented herein are not necessarily mutually exclusive, but may be interchanged to meet various needs as would be appreciated by one of skill in the art.

It is to be understood that the phraseology or terminology used herein is for the purpose of description and not of limitation. The breadth and scope of the present disclosure should not be limited by any of the above-described exemplary embodiments but should be defined only in accordance with the following claims and their equivalents.

What is claimed is:

1. A method of manufacturing a preform, the method comprising:
positioning at least one glass tube in a glass outer cladding to form a preform precursor, the glass tube comprising a first open end and a second open end;
forming a preform from the preform precursor; and
thermally treating at least one of the preform precursor and the preform, the thermally treating comprising:
sealing the first open end and the second open end of the glass tube to form a closed tube; and
heating and/or cooling the glass tube to manipulate gas pressure within the closed glass tube.

2. The method of claim 1, wherein the thermally treating the glass tube comprises heating the glass tube to a temperature from about 1100° C. to about 2200° C.

3. The method of claim 2, wherein the thermally treating the glass tube comprises heating the glass tube to a temperature from about 1100° C. to about 1700° C.

4. The method of claim 1, wherein the thermally treating the glass tube comprises cooling the glass tube to a temperature from about 0° C. or lower.

5. The method of claim 1, further comprising consolidating the preform precursor to form the preform, and wherein the thermally treating the glass tube is before depositing soot on the preform precursor during the consolidation of the preform precursor.

6. The method of claim 1, further comprising thermally treating a second glass tube, the second glass tube being a nested tube disposed radially interior of the glass tube.

7. The method of claim 6, wherein during the thermal treatment of the glass tube and the thermal treatment of the second glass tube, the glass tube is heated to a different temperature than the second glass tube.

8. The method of claim 1, wherein the thermally treating the glass tube comprises heating gas in a radially central portion of the glass tube to a higher temperature than gas at a radially peripheral portion of the glass tube.

9. The method of claim 1, further comprising consolidating the preform precursor to form the preform, and wherein the thermally treating the glass tube is after depositing soot on the preform precursor during the consolidation of the preform precursor.

10. The method of claim 9, wherein the glass tube that experiences the thermal treatment is a glass tube of the preform.

11. The method of claim 9, further comprising redrawing the preform before drawing the preform and after the thermally treating the glass tube.

12. The method of claim 11, wherein a ratio between a wall thickness of the glass tube before the redraw to after the redraw is about 1.5 or more.

13. The method of claim 11, wherein an outer diameter of the glass tube after the redrawing of the glass tube is from about 0.25 mm to about 10 mm.

14. The method of claim 13, wherein the outer diameter is from about 0.50 mm to about 8 mm.

15. The method of claim 1, wherein the thermally treating the glass tube comprises heating the glass tube and increasing gas pressure within the glass tube.

16. The method of claim 15, wherein the glass tube comprises an inner capillary, and heating the glass tube increases an outer diameter of the inner capillary and decreases a wall thickness of the glass tube.

17. The method of claim 1, wherein the thermally treating the glass tube comprises cooling the glass tube and decreasing gas pressure within the glass tube.

18. The method of claim 17, wherein the glass tube comprises an inner capillary, and cooling the glass tube decreases an outer diameter of the inner capillary and increases a wall thickness of the glass tube.

19. The method of claim 1, wherein the at least one glass tube comprises a second glass tube, the thermally treating the glass tube comprising heating the glass tube to increase a gas pressure within the glass tube, and the method further comprising cooling the second glass tube and sealing both ends of the second glass tube to form a second closed tube to decrease a gas pressure within the second glass tube.

20. The method of claim 1, wherein the at least one glass tube comprises a second glass tube, the thermally treating the glass tube comprising heating the glass tube to a first temperature to increase a gas pressure within the glass tube, and the method further comprising sealing both ends of the second glass tube to form a second closed tube and heating the second glass tube to a second temperature to increase a gas pressure within the second glass tube.
